(19) United States
(12) Patent Application Publication
(10) Pub. No.: US 2016/0129771 A1
(43) Pub. Date: May 12, 2016

(54) PERIPHERAL STRUCTURE OF WINDSHIELD FOR VEHICLE

(71) Applicant: TOYOTA SHATAI KABUSHIKI KAISHA, Kariya-shi (JP)

(72) Inventors: Junji NAKAI, Kariya-shi (JP); Kazuyoshi HOUJOU, Kariya-shi (JP); Shun MORISHITA, Kariya-shi (JP)

(21) Appl. No.: 14/884,216

(22) Filed: Oct. 15, 2015

(30) Foreign Application Priority Data
Nov. 5, 2014 (JP) 2014-225004

(51) Int. Cl. B60J 1/20

(52) U.S. Cl. CPC B60J 10/02

(57) ABSTRACT

A peripheral structure of a windshield for a vehicle may include a front opening formed in a vehicle body and configured to be closed by the windshield, a depressed portion formed in the vehicle body so as to extend along the front opening and configured to receive a circumferential periphery of the windshield, and a molding attached to the depressed portion. The depressed portion has a bottom wall and a side wall. The bottom wall of the depressed portion is configured such that the circumferential periphery of the windshield is secured thereto. The molding is configured to cover a channel formed between the circumferential periphery of the windshield received in the depressed portion and the side wall of the depressed portion. The molding has a vent portion that is configured to release air in the channel therethrough.

### BACKGROUND OF THE INVENTION

1. Field of the Invention

The present invention relates to a peripheral structure of a windshield for a vehicle.

2. Description of Related Art

Such a peripheral structure of a windshield for a vehicle is shown, for example, in JP 10-035272 A. As shown in FIGS. 8 and 9, in the peripheral structure taught by JP 10-035272 A, a vehicle body 100 has a front opening 106 that is configured to be closed by a windshield 105. The front opening 106 is defined by a roof panel 101 and right and left front pillars 103 (one of which is shown) of the vehicle body 100. Further, the vehicle body 100 has a stepped or depressed portion K in which a circumferential periphery of a windshield 105 is received (FIG. 9). The depressed portion K is continuously formed in a front periphery of the roof panel 101 and inner peripheries of the pillars 103 so as to extend along the front opening 106. As shown in FIG. 9, the depressed portion K has a roof-side bottom wall (windshield fixture portion) 101k and pillar-side bottom walls (windshield fixture portions) 103k to which the circumferential periphery of the windshield 105 is secured. The depressed portion K has a roof-side side (upper) wall 101e that is continuous with an outer (ornamental) surface 101m of the roof panel 101 and the roof-side bottom wall 101k. Further, the depressed portion K has pillar-side side walls 103e that are respectively continuous with outer (ornamental) surfaces 103m of the front pillars 103 and the pillar-side bottom walls 103k.

As shown in FIG. 9, the windshield 105 is secured to the roof-side bottom wall 101k and the pillar-side bottom walls 103k of the depressed portion K via an elongated weather-strip or molding 107 attached to the circumferential periphery thereof. The molding 107 includes an attachment portion 107s connected to the circumferential periphery of the windshield 105 and a lip portion 107r projected from the attachment portion 107s toward the side walls 101e and 103e of the depressed portion K. The lip portion 107r elastically contacts the side walls 101e and 103e of the depressed portion K, so as to close a space or channel M formed between the circumferential periphery of the windshield 105 and the side walls 101e and 103e of the depressed portion K.

As shown by an arrowed dotted line in FIG. 8, in the peripheral structure of the windshield 105 described above, while the vehicle is moving, air (wind) in an engine room may enter the channel M formed between the periphery of the windshield 105 and the side walls 101e and 103e of the depressed portion K. The air introduced into the channel M may flow through the channel M toward the roof panel 101 along the front pillars 103. At this time, an air pressure in the channel M may be increased. As a result, the increased air pressure may be applied to the lip portion 107r of the molding 107 closing the channel M in a direction to push the lip portion 107r out of the channel M. That is, the air pressure may be applied to the lip portion 107r as a push-out force. Also, while the vehicle is moving, ambient air may flow vertically (upward) and laterally along an outer surface of the windshield 105. At that time, a negative pressure can be produced along the lip portion 107r of the molding 107 due to a flow of the ambient air. The negative pressure thus produced may be applied to the lip portion 107r in a direction to draw the lip portion 107r out of the channel M. That is, the negative pressure may be applied to the lip portion 107r as a draw-out (suction) force.

As will be recognized, when a sum of the push-out force and the draw-out force applied to the lip portion 107r of the molding 107 is greater than an elastic force of the lip portion 107r, a distal end periphery of the lip portion 107r can move upward with respect to or separate from the side walls 101e and 103e of the depressed portion K, so as to form a clearance between the distal end periphery of the lip portion 107r and the side walls 101e and 103e of the depressed portion K. As a result, the air flowing within the channel M may be released from the channel M into the atmosphere, so that the sum of the push-out force and the draw-out force applied to the lip portion 107r can respectively be reduced. As a result, the distal end periphery of the lip portion 107r of the molding 107 can be restored by the own elastic force of the lip portion 107r, so as to bring into elastically contact with the side walls 101e and 103e of the depressed portion K again.

Thus, while the vehicle is moving, the lip portion 107r of the molding 107 may repeatedly separate from and bring into contact with the side walls 101e and 103e of the depressed portion K. As a result, the lip portion 107r of the molding 107 may be vibrated. This may lead to production of noise in the lip portion 107r of the molding 107. Generally, because the push-out force and the draw-out force applied to the lip portion 107r can be maximized at the front periphery of the roof panel 101, the noise may be more likely to be produced in the vicinity of the roof panel 101.

Thus, there is a need in the art for an improved peripheral structure of a windshield for a vehicle.

### BRIEF SUMMARY OF THE INVENTION

For example, one aspect of the present teaching may provide a peripheral structure of a windshield for a vehicle, which may include a front opening formed in a vehicle body and configured to be closed by the windshield, a depressed portion formed in the vehicle body so as to extend along the front opening and configured to receive a circumferential periphery of the windshield, and a molding attached to the depressed portion. The depressed portion has a bottom wall and a side wall. The bottom wall of the depressed portion is configured such that the circumferential periphery of the windshield is secured thereto. The molding is configured to cover a channel formed between the circumferential periphery of the windshield received in the depressed portion and the side wall of the depressed portion. The molding has a vent portion that is configured to release air in the channel therethrough.

According to the aspect, the molding may have the vent portion that is capable of releasing the air in the channel therethrough. Therefore, while the vehicle is moving, the air introduced into the channel may be released into the atmosphere via the vent portion formed in the molding. As a result, a push-out pressure (push-out force) that functions to push the molding out of the channel may be prevented from being increased. Further, because the air in the channel may be released into the atmosphere via the vent portion, a negative pressure (draw-out force) produced along the molding due to the ambient air that flows toward a roof of the vehicle body along an outer surface of the windshield may be minimized. Therefore, a sum of the push-out pressure (push-out force) and the negative pressure (draw-out force) applied to the molding may be prevented from exceeding an elastic force of the molding that functions to press the molding against the side wall of the depressed portion. As a result, the molding may be prevented from being displaced with respect to or separating from the side wall of the depressed portion. Therefore, production of noise in the molding may be effectively prevented.

Optionally, the molding may have a lip portion of which a distal end portion thereof is configured to be elastically deformed and pressed against the side wall of the depressed portion. Further, the vent portion may be formed in the lip portion

Other objects, features, and advantages, of the present invention will be readily understood after reading the following detailed description together with the accompanying drawings and the claims.

### BRIEF DESCRIPTION OF THE DRAWINGS

FIG. 1 is a perspective view of a vehicle having a peripheral structure of a windshield according to a representative embodiment of the present invention;

FIG. 2 is an enlarged view of an encircled portion II of FIG. 1;

FIG. 3 is a sectional view taken along line III-III of FIG. 2;

FIG. 4 is a sectional view taken along line IV-IV of FIG. 2;

FIG. 5 is a plan view of an upper molding that is used in the peripheral structure of the present embodiment;

FIG. 6 is a sectional view taken along line VI-VI of FIG. 5;

FIG. 7 is a plan view of an upper molding in a modified form; and

FIG. 8 is a perspective view of a vehicle having a conventional peripheral structure of a windshield;

FIG. 9 is a sectional view taken along line IX-IX of FIG. 8.

### DETAILED DESCRIPTION OF THE INVENTION

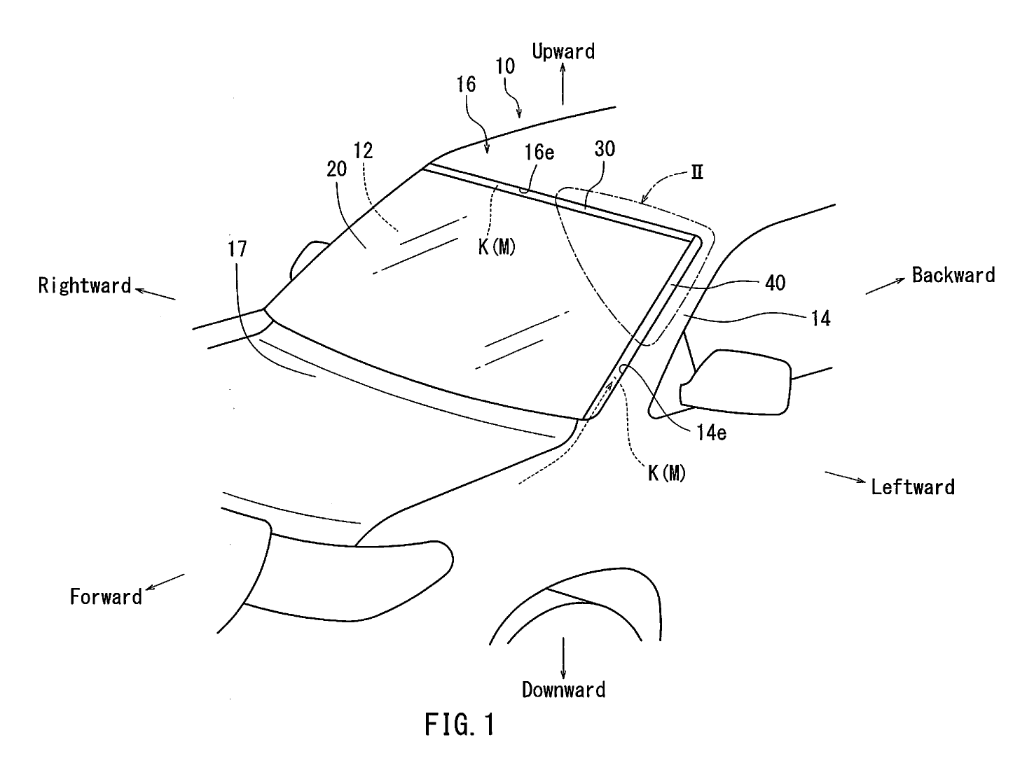

A peripheral structure of a windshield for a vehicle according to a representative embodiment of the present invention will now be described with reference to FIGS. 1 to 7. Further, forward and backward, rightward and leftward, and upward and downward in the drawings respectively correspond to forward and backward, rightward and leftward, and upward and downward of the vehicle.

### Regarding Outline of Peripheral Structure of Windshield for Vehicle

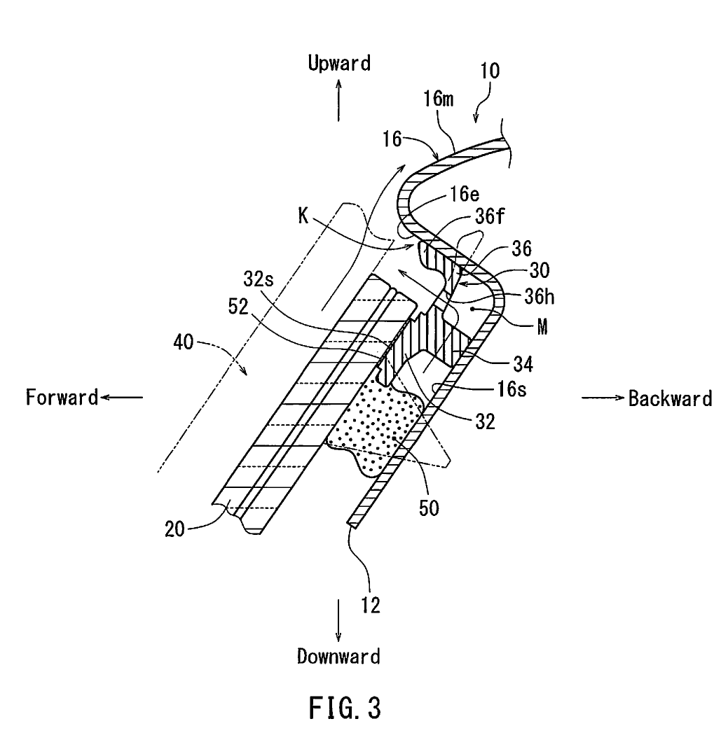

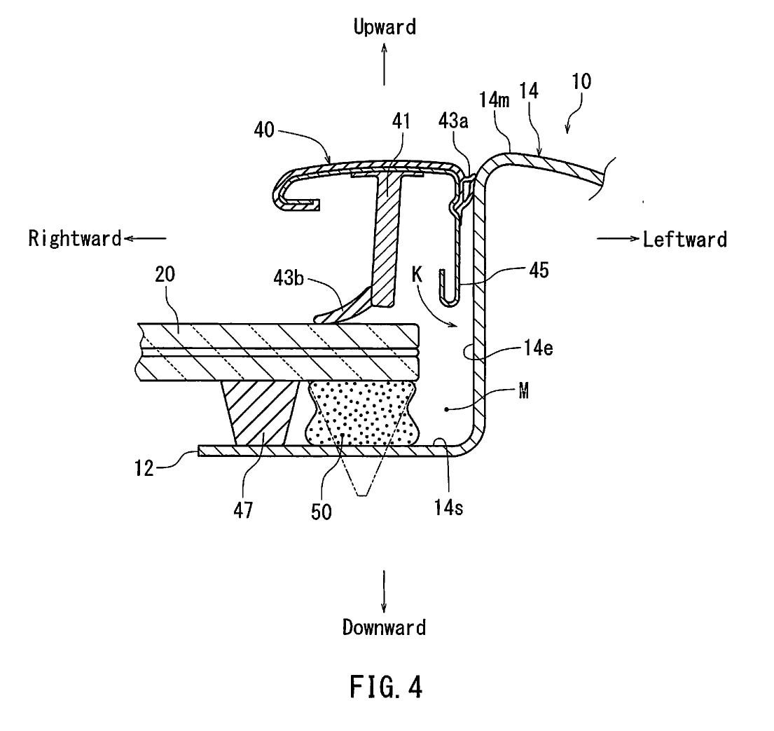

As shown in FIG. 1, a vehicle body (cabin) 10 may have a roof panel 16, and right and left front pillars 14 (only the left front pillar is shown) that respectively support front side portions of the roof panel 16. Further, the vehicle body 10 may have a cowl top panel (not shown) positioned between lower end portions of the front pillars 14 and extending in a vehicle width direction. The cowl top panel may be positioned behind and below an engine hood 17. Further, the vehicle body 10 may have a front opening 12 that is configured to be closed by a windshield 20. The front opening 12 may be defined by the roof panel 16, the right and left front pillars 14 and the cowl top panel. Further, as shown in FIGS. 1 to 4, the vehicle body 10 may have a stepped or depressed portion K in which a circumferential periphery of the windshield 20 is received. The depressed portion K may be continuously formed in a front periphery of the roof panel 16 and inner peripheries of the front pillars 14 so as to extend along the front opening 12. That is, the depressed portion K may have a frame shape in plan. The depressed portion K may preferably be formed by depressing the front periphery of the roof panel 16 and the inner peripheries of the front pillars 14. As shown in FIGS. 3 and 4, the depressed portion K may have an internal flange-shaped roof-side bottom wall (windshield fixture portion) 16s and internal flange-shaped pillar-side bottom walls (windshield fixture portions) 14s to which a rear surface of the circumferential periphery of the windshield 20 is secured. The depressed portion K may have a roof-side side (upper) wall 16e that is continuous with an outer (ornamental) surface 16m of the roof panel 16 and the roof-side bottom wall 16s. Further, the depressed portion K may have pillar-side side walls 14e that are respectively continuous with outer (ornamental) surfaces 14m of the front pillars 14 and the pillar-side bottom walls 14s.

In particular, as shown in FIG. 3, the front periphery of the roof panel 16 may be folded so as to have a substantially Z-shape in cross section. As a result, the depressed portion K corresponding to the roof panel 16 may be formed. That is, the depressed portion K corresponding to the roof panel 16 may be composed of the roof-side side wall 16e that is continuous with the outer surface 16m of the roof panel 16 at an acute angle, and the roof-side bottom wall 16s that is continuous with the roof-side side wall 16e at a substantially right angle.

Further, as shown in FIG. 4, the inner (right) periphery of the left pillar 14 may be folded so as to have a substantially Z-shape in cross section. As a result, the depressed portion K corresponding to the left front pillar 14 may be formed. That is, the depressed portion K corresponding to the left front pillar 14 may be composed of the left pillar-side side wall 14e that is continuous with the outer surface 14m of the left front pillar 14 at an acute angle, and the left pillar-side bottom wall 14s that is continuous with the left pillar-side side wall 14e at a substantially right angle.

Similarly, the inner (left) periphery of the right pillar (not shown) may be folded so as to have a substantially Z-shape in cross section. As a result, the depressed portion corresponding to the right front pillar may be formed. That is, the depressed portion corresponding to the right front pillar may be composed of the right pillar-side side wall that is continuous with the outer surface of the right front pillar at an acute angle, and the right pillar-side bottom wall that is continuous with the right pillar-side side wall at a substantially right angle.

Further, the cowl top panel may have a support wall (windshield fixture portion) (not shown) formed therein. The support wall of the cowl top panel may preferably be configured so as to be substantially flush with the pillar-side bottom walls 14s of the depressed portion K.

### <Regarding Windshield 20>

As shown in FIG. 1, the windshield 20 may be formed of a double-glazed glass and have a substantially rectangular shape substantially corresponding to a shape of the front opening 12 (a planar shape of the depressed portion K). In particular, the windshield 20 may be configured such that a predetermined clearance may be formed between the circumferential periphery (circumferential surface) of the windshield 20 and the side walls 14e and 16e of the depressed portion K when the circumferential periphery of the windshield 20 is disposed on the bottom walls 14s and 16s of the depressed portion K. Therefore, as shown in FIGS. 3 and 4, when the circumferential periphery of the windshield 20 is disposed on the bottom walls 14s and 16s of the depressed portion K, a channel M may be continuously formed between the circumferential periphery of the windshield 20 and the side walls 14e and 16e of the depressed portion K so as to extend along the front pillars 14 and the roof panel 16. Further, the depressed portion K (the windshield 20) may be provided with elongated strip-shaped side moldings 40 and an elongated strip-shaped upper molding 30 which will be hereinafter described.

As shown in FIG. 4, the windshield 20 may have elongated elastic spacers or positioning members 47 that are respectively secured to a rear surface thereof. The positioning members 47 may respectively be positioned along right and left (lateral) side peripheral portions of the windshield 20. Each of the positioning members 47 may preferably have a trapezoidal shape in cross section. The positioning members 47 may function to maintain a distance between the rear surface of the windshield 20 and the pillar-side bottom walls 14s of the depressed portion K constant. Therefore, as shown in FIG. 4, when the windshield 20 is disposed on the bottom walls 14s and 16s of the depressed portion K, a predetermined clearance may be formed between the rear surface of the windshield 20 and the pillar-side bottom walls 14s of the depressed portion K.

### <Regarding Side Moldings 40>

The side moldings 40 may respectively be configured to close or cover the channel M corresponding to the front pillars 14, i.e., the channel M formed between the circumferential periphery of the windshield 20 and the pillar-side side walls 14e of the depressed portion K. As shown in FIG. 4, each of the side moldings 40 may preferably have an ornamental main body portion 41, a pillar-side sealing portion 43a, a windshield-side sealing portion 43b and hooks 45 that are integrally formed. The hooks 45 may preferably be formed in the main body portion 41 at intervals in a longitudinal direction of the main body portion 41. The side moldings 40 thus constructed may respectively be attached to the depressed portion K corresponding to the front pillars 14. In particular, the side moldings 40 may respectively be positioned along the right and left side peripheral portions of the windshield 20 disposed on the bottom walls 14s and 16s of the depressed portion K while the pillar-side sealing portion 43a and the windshield-side sealing portion 43b of each of the side moldings 40 respectively contact an outer surface of the windshield 20 and each of the pillar-side side walls 14e. Further, the hooks 45 of each of the side moldings 40 may be engaged with engagement portions (not shown) formed in each of the front pillars 14. Thus, the side moldings 40 may respectively be secured to the depressed portion K while covering the channel M corresponding to the front pillars 14.

### <Regarding Upper Molding 30>

The upper molding 30 may be configured to close or cover the channel M corresponding to the roof panel 16, i.e., the channel M formed between the circumferential periphery of the windshield 20 and the roof-side side wall 16e of the depressed portion K. As shown in FIGS. 3 and 6, the upper molding 30 may preferably have an elongated base portion 34, an elongated flange-shaped fixing portion 32 and an elongated lip portion 36 that are integrally formed. The fixing portion 32 may be projected from the base portion 34 in a lateral direction so as to be formed as a portion of the base portion 34. Conversely, the lip portion 36 may be projected from the base portion 34 in an opposite direction of the fixing portion 32. As shown in FIG. 3, the upper molding 30 thus constructed may be attached to the depressed portion K corresponding to the roof panel 16. In particular, the upper molding 30 may be positioned along an upper peripheral portion of the windshield 20 disposed on the bottom walls 14s and 16s of the depressed portion K while the base portion 34, the lip portion 36 and the fixing portion 32 respectively contact the roof-side bottom wall 16s of the depressed portion K, the roof-side side wall 16e of the depressed portion K and the rear surface of the windshield 20. Further, the fixing portion 32 of the upper molding 30 may have a thickened flange shape and have a flattened upper surface 32s facing the rear surface of the windshield 20. The upper surface 32s of the fixing portion 32 may be adhered to the rear surface of the windshield 20 via a double-sided tape (adhesive member) 52. Thus, the upper molding 30 may be secured to the depressed portion K while covering the channel M corresponding to the roof panel 16.

As described above, the base portion 34 of the upper molding 30 may contact the roof-side bottom wall 16s of the depressed portion K. Further, the base portion 34 of the upper molding 30 may contact the rear surface of the windshield 20 via the fixing portion 32. Therefore, the upper molding 30 may function to maintain a distance between the rear surface of the windshield 20 and the roof-side bottom walls 16s of the depressed portion K constant.

The base portion 34 of the upper molding 30 may function as a substantial portion that functions to maintain the distance between the rear surface of the windshield 20 and the roof-side bottom walls 16s of the depressed portion K constant. As shown in FIGS. 3 and 6, the base portion 34 may be configured so as to be positioned adjacent to the circumferential periphery of the windshield 20 disposed on the bottom walls 14s and 16s of the depressed portion K when the upper molding 30 is positioned along the upper peripheral portion of the windshield 20. Further, the base portion 34 may have a substantially rectangular shape in cross section.

The lip portion 36 of the upper molding 30 may function as a substantial portion that closes the channel M corresponding to the roof panel 16. As shown in FIGS. 3 and 6, the lip portion 36 may have an elastically deformable portion 36f that is formed in a distal end portion thereof. The elastically deformable portion 36f may be configured to be elastically deformed and pressed against the roof-side side wall 16e of the depressed portion K when the upper molding 30 is attached to the depressed portion K.

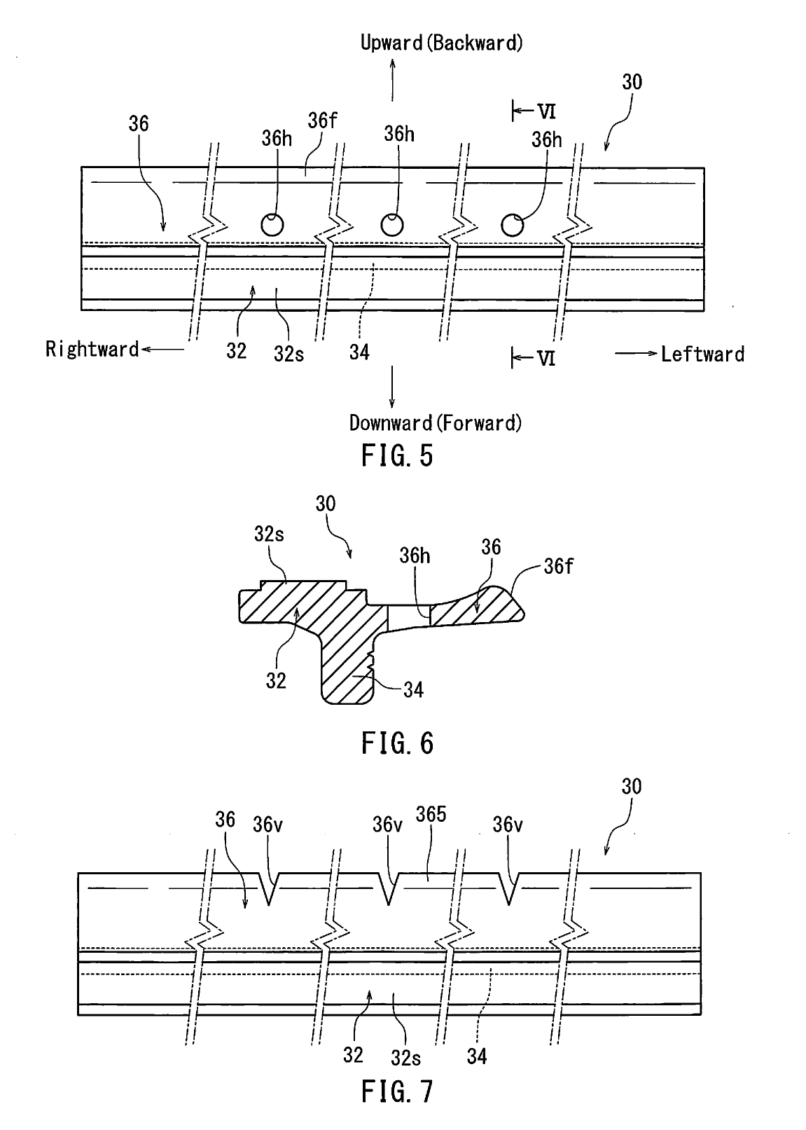

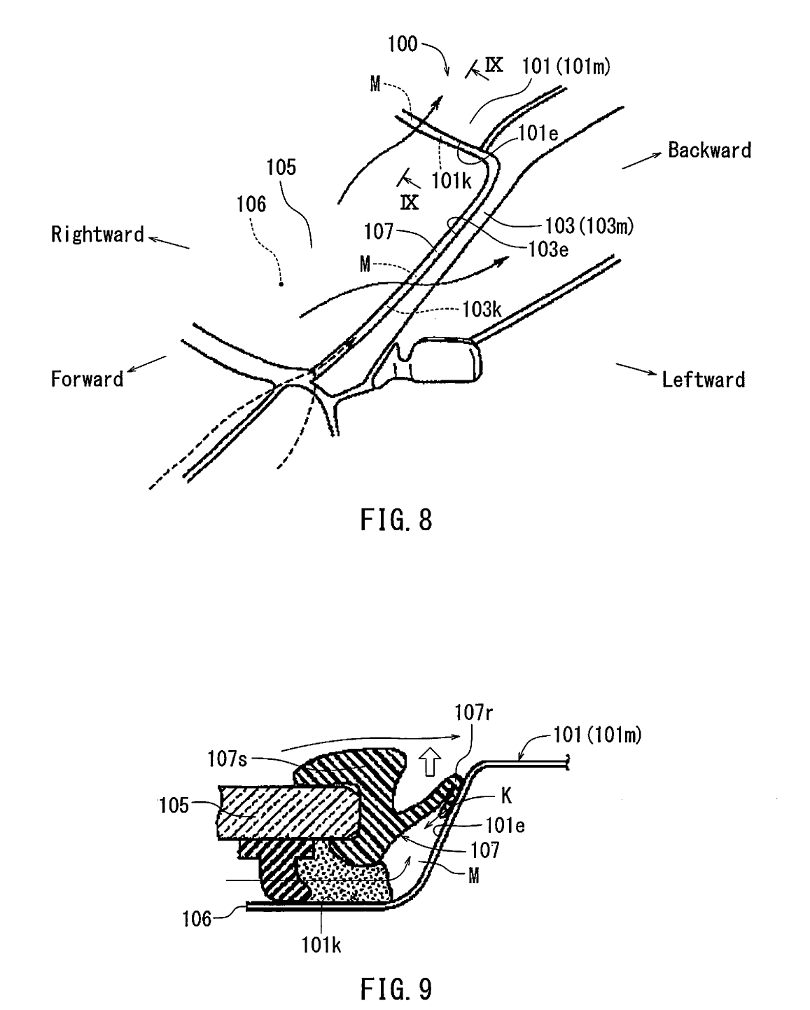

As shown in FIGS. 3, 5 and 6, the lip portion 36 of the upper molding 30 may have a plurality of circular through holes 36h (depressurizing or vent portion) that are formed in a proximal end portion thereof. As shown in FIG. 5, the through holes 36h may preferably be formed in a substantially longitudinally central portion of the lip portion 36 at intervals. Thus, the channel M corresponding to the roof panel 16 may be opened to the atmosphere via the through holes 36h, so that air in the channel M can be released therethrough.

### <Regarding Installation of Moldings 30 and 40>

First, the upper molding 30 may be positioned along the upper peripheral portion of the windshield 20. Thereafter, the upper surface 32s of the fixing portion 32 of the upper molding 30 may be adhered to the rear surface of the windshield 20 via the double-sided tape 52, so that the upper molding 30 may be attached to the windshield 20. Further, the positioning members 47 may respectively be positioned along the side peripheral portions of the windshield 20. Thereafter, the positioning members 47 may respectively be secured to the rear surface of the windshield 20 using double-sided tapes or other such adhesive members (not shown). Subsequently, a rubber-based adhesive or urethane adhesive 50 may be applied to the rear surface of the windshield 20 so as to extend along the entire circumferential periphery thereof. In particular, as shown in FIG. 3, in the upper peripheral portion of the windshield 20, the urethane adhesive 50 may be applied to the rear surface of the windshield 20 so as to extend along an inner periphery of the fixing portion 32 of the upper molding 30. Conversely, as shown in FIG. 4, in the side peripheral portions of the windshield 20, the urethane adhesive 50 may be applied to the rear surface of the windshield 20 so as to extend along an outer side of each of the positioning members 47.

Next, the windshield 20 having the upper molding 30 and the urethane adhesive 50 may be positioned on the bottom walls 14s and 16s of the depressed portion K formed in the vehicle body 10 and the support wall of the cowl top panel such that the channel M may be formed along the circumferential periphery of the windshield 20. Further, the windshield 20 may include a positioning member (not shown) that allows the windshield 20 to be appropriately positioned on the bottom walls 14s and 16s (the depressed portion K). Thereafter, the windshield 20 thus disposed may be pressed against the vehicle body 10, so that the circumferential periphery of the windshield 20 is adhered to the bottom walls 14s and 16s of the depressed portion K and the support wall of the cowl top panel via the urethane adhesive 50. Thus, the windshield 20 may be attached to the vehicle body 10. As a result, the upper molding 30 may respectively be secured to the depressed portion K. At this time, as shown in FIG. 3, in the upper peripheral portion of the windshield 20, the elastically deformable portion 36f of the lip portion 36 of the upper molding 30 may be elastically deformed and pressed against the roof-side side wall 16e of the depressed portion K. Further, at this time, the through holes 36h formed in the lip portion 36 may be positioned at a substantially widthwise central portion of the front periphery of the roof panel 16 (a substantially widthwise central portion of the vehicle) because the through holes 36h are formed in the longitudinally central portion of the lip portion 36 (the upper molding 30). Thus, the channel M formed between the circumferential periphery (the upper peripheral portion) of the windshield 20 and the roof-side side wall 16e of the depressed portion K may substantially be covered by the upper molding 30.

Subsequently, as shown in FIG. 4, the side moldings 40 may respectively be positioned along the side peripheral portions of the windshield 20 secured to the bottom walls 14s and 16s of the depressed portion K while the pillar-side sealing portion 43a and the windshield-side sealing portion 43b of each of the side moldings 40 respectively contact an outer surface of the windshield 20 and each of the pillar-side side walls 14e. Further, the hooks 45 of each of the side moldings 40 may be engaged with engagement portions (not shown) formed in each of the front pillars 14, so that the side moldings 40 may respectively be secured to the depressed portion K. Thus, the channel M formed between the circumferential periphery (the side peripheral portions) of the windshield 20 and the pillar-side side walls 14e of the depressed portion K may substantially be covered by the side moldings 40.

### <Regarding Operation of Upper Molding 30>

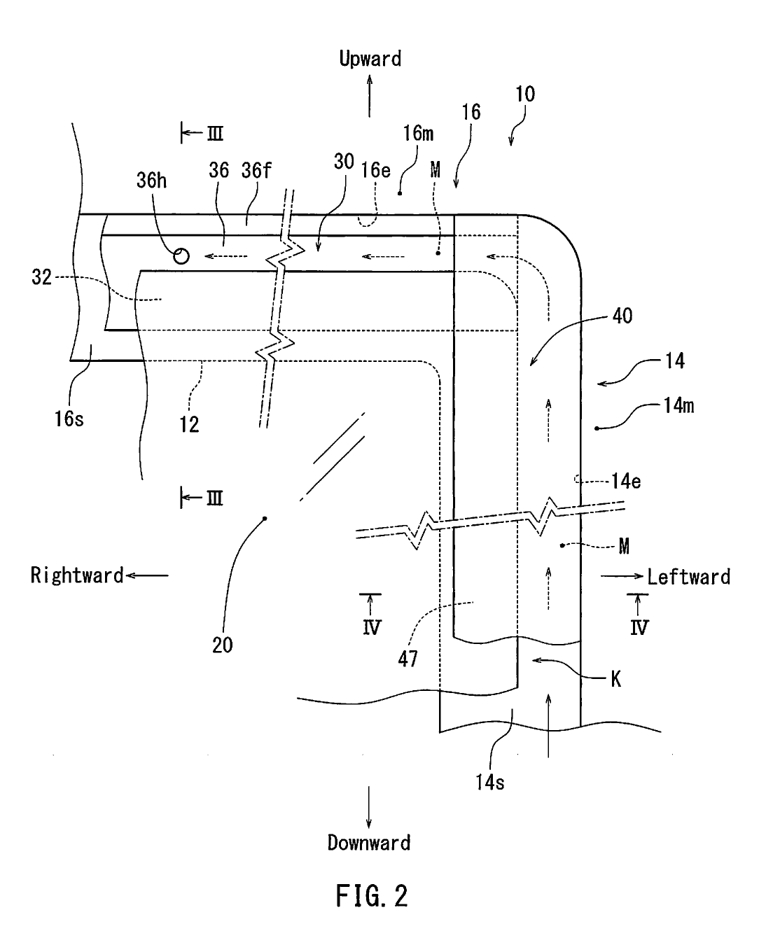

As shown by an arrowed dotted line in FIG. 1, while the vehicle is moving, air in an engine room may enter the channel M (FIGS. 2 and 4) covered by the side moldings 40. As shown by arrowed dotted lines in FIG. 2, the air introduced into the channel M may flow upward along the front pillars 14 (the pillar-side side walls 14e of the depressed portion K) and the side moldings 40. The air may then flow into the channel M (FIGS. 2 and 3) covered by the upper molding 30. Thereafter, the air may be transferred to the widthwise central portion of the vehicle (the roof panel 16) along the roof panel 16 (the roof-side side wall 16e of the depressed portion K) and the upper molding 30. The air reaching the widthwise central portion of the vehicle may be released from the channel M into the atmosphere via the through holes 36h formed in the lip portion 36. Therefore, an air pressure within the channel M may be prevented from being excessively increased. As a result, a push-out pressure (push-out force) that functions to push the lip portion 36 (the elastically deformable portion 36f) of the upper molding 30 out of the channel M may be prevented from being increased.

Conversely, because the air may be released from the channel M via the through holes 36h formed in the lip portion 36 of the upper molding 30, a negative pressure produced along the lip portion 36 of the upper molding 30 due to ambient air that flows toward the roof panel 16 along an outer surface of the windshield 20 may be minimized. That is, a draw-out pressure (draw-out force) that functions to draw the lip portion 36 of the upper molding 36 out of the channel M may be prevented from being increased.

Therefore, a sum of the push-out pressure (push-out force) and the negative pressure (draw-out force) applied to the lip portion 36 of the upper molding 30 may be prevented from exceeding an elastic force of the lip portion 36 that functions to press the elastically deformable portion 36f of the lip portion 36 against the roof-side side wall 16e of the depressed portion K (the roof panel 16). As a result, the lip portion 36 of the upper molding 30 may be prevented from moving upward with respect to or separating from the roof-side side wall 16e of the depressed portion K. That is, the lip portion 36 of the upper molding 30 may be prevented from being vibrated. Thus, production of noise in the lip portion 36 of the upper molding 30 may be prevented.

### <Regarding Advantage of Peripheral Structure of Windshield 20 of Present Embodiment>

According to the peripheral structure of the windshield 20 according to the present embodiment, the lip portion 36 of the upper molding 30 may have the through holes 36h (vent portion) that are configured to release the air in the channel M therethrough. Therefore, the air introduced into the channel M may be released into the atmosphere via the through holes 36h formed in the lip portion 36 of the upper molding 30. As a result, the push-out pressure (push-out force) that functions to push the lip portion 36 of the upper molding 30 out of the channel M may be prevented from being increased. Further, because the air in the channel M may be released into the atmosphere via the through holes 36h, the negative pressure (draw-out force) produced along the lip portion 36 of the upper molding 30 due to the ambient air that flows toward the roof panel 16 along the outer surface of the windshield 20 may be minimized. Therefore, the sum of the push-out pressure (push-out force) and the negative pressure (draw-out force) applied to the lip portion 36 of the upper molding 30 may be prevented from exceeding the elastic force of the lip portion 36 that functions to press the elastically deformable portion 36f of the lip portion 36 against the roof-side side wall 16e of the depressed portion K formed in the roof panel 16. As a result, the lip portion 36 of the upper molding 30 may be prevented from being displaced with respect to or separating from the roof-side side wall 16e of the depressed portion K. Therefore, production of noise in the lip portion 36 of the upper molding 30 may be prevented.

In addition, the through holes 36h may be formed in the longitudinally central portion of the lip portion 36 of the upper molding 30 at intervals. As a result, the air in the channel M may be effectively released into the atmosphere via the through holes 36h. This may effectively prevent production of noise in the lip portion 36 of the upper molding 30.

Various changes and modifications may be made to the peripheral structure of the windshield 20. For example, in the embodiment, the circular through holes 36h are formed in the lip portion 36 of the upper molding 30 in order to release the air within the channel M. However, the shape of the through holes 36h may be changed as necessary. For example, the through holes 36h may be replaced with elongate through holes, rectangular through holes or semicircular through holes.

Further, in the embodiment, the through holes 36h are formed in the substantially longitudinally central portion of the lip portion 36 of the upper molding 30 at intervals. However, the through holes 36h may be formed in the lip portion 36 over the entire length thereof at intervals.

Further, in the embodiment, the through holes 36h are formed in the lip portion 36 of the upper molding 30 in order to release the air within the channel M. However, as shown in FIG. 7, the through holes 36h may be replaced with V-shaped notches 36v formed in the lip portion 36.

A representative example of the present invention has been described in detail with reference to the attached drawings. This detailed description is merely intended to teach a person of skill in the art further details for practicing preferred aspects of the present invention and is not intended to limit the scope of the invention. Only the claims define the scope of the claimed invention. Therefore, combinations of features and steps disclosed in the foregoing detail description may not be necessary to practice the invention in the broadest sense, and are instead taught merely to particularly describe detailed representative examples of the invention. Moreover, the various features taught in this specification may be combined in ways that are not specifically enumerated in order to obtain additional useful embodiments of the present invention.

What is claimed is:

1. A peripheral structure of a windshield for a vehicle, comprising:
a front opening formed in a vehicle body and configured to be closed by the windshield,
a depressed portion formed in the vehicle body so as to extend along the front opening and configured to receive a circumferential periphery of the windshield, and
a molding attached to the depressed portion,
wherein the depressed portion has a bottom wall and a side wall,
wherein the bottom wall of the depressed portion is configured such that the circumferential periphery of the windshield is secured thereto,
wherein the molding is configured to cover a channel formed between the circumferential periphery of the windshield received in the depressed portion and the side wall of the depressed portion, and
wherein the molding has a vent portion that is configured to release air in the channel therethrough.

2. The peripheral structure as defined in claim 1, wherein the molding has a lip portion of which a distal end portion thereof is configured to be elastically deformed and pressed against the side wall of the depressed portion, and wherein the vent portion is formed in the lip portion.

3. The peripheral structure as defined in claim 2, wherein the vent portion is formed in the lip portion of the molding that is secured to an upper peripheral portion of the windshield.

4. The peripheral structure as defined in claim 1, wherein the vent portion comprises a through hole.

5. The peripheral structure as defined in claim 3, wherein the vent portion is formed in a longitudinally central portion of the lip portion.

6. The peripheral structure as defined in claim 2, wherein the vent portion comprises a plurality of vent portions that are longitudinally positioned along the lip portion.

7. The peripheral structure as defined in claim 1, wherein the molding is secured to the circumferential periphery of the windshield.

8. The peripheral structure as defined in claim 1, wherein the vent portion comprises a notch.
